(19) United States
(12) Patent Application Publication
(10) Pub. No.: US 2024/0428185 A1
(43) Pub. Date: Dec. 26, 2024

(54) FACTORY ACTIVATION OF DIGITAL IDENTITIES

(71) Applicant: Digimarc Corporation, Beaverton, OR (US)

(72) Inventors: Dominique GUINARD, Troistorrents (CH); Perraine BRADLEY, London (GB); Shmuel SILVERMAN, Novato, CA (US)

(21) Appl. No.: 18/672,291

(22) Filed: May 23, 2024

Related U.S. Application Data
(63) Continuation of application No. PCT/US2022/050767, filed on Nov. 22, 2022.
(60) Provisional application No. 63/282,380, filed on Nov. 23, 2021.

(51) Int. Cl. G06Q 10/087; H04L 9/08

(52) U.S. Cl. CPC G06Q 10/087; H04L 9/0877

(57) ABSTRACT

An electronic device and related technology for activating a physical product is described. During operation, the electronic device may activate the product based at least in part on a context of the product, including: a Factory that produces the product, a zone in the Factory that produces the product, and/or a purchase order specifying the product. Then, the electronic device may pair or associate at least one unique identifier (or serial identification) of the product with a non-unique identifier of the product (such as a product type). Next, the electronic device may provide, addressed to the computer, information specifying the context, the at least one unique identifier and the non-unique identifier. This information may correspond to a digital twin of the activated product, which is generated and maintained by the computer. The digital twin may allow global production and/or a lifecycle of the product to be tracked, thereby reducing or eliminating intentional duplication or overproduction of other instances of the product, e.g., at the Factory.

### RELATED APPLICATION DATA

This application is a US Nationalization of International Patent Application No. PCT/US2022/050767, filed Nov. 22, 2023, and published as WO 2023/096924, which claims the benefit of U.S. Provisional Patent Application No. 63/282,380, filed Nov. 23, 2021. Each of the above referenced patent documents is hereby incorporated herein by reference in its entirety.

### TECHNICAL FIELD

The described embodiments relate to methods, systems, and technology for activating a digital identity associated with a physical product.

### BACKGROUND AND SUMMARY

Supply-chain integrity issues represent a problem set more acute than ever before. In fields such as drinks, consumer packaged goods, or apparel, these typically are significant challenges in terms of financial losses, but also for health and safety. For example, in the production of apparel items, there are a number of specific supply-chain integrity issues that often occur, such as the production of counterfeits, the production of backdoor goods or the parallel import of goods. These problems usually arise from opaque supply chains and the lack of real-time monitoring for Brands. Notably, Brands are largely unable to track, in real-time, the production of their purchase orders. Digital solutions could help, but the physical and digital worlds are still fairly disconnected when it comes to the manufacturing of goods.

In principle, these problems can be addressed by assigning a unique serial number to an item so that production can be tracked. However, in practice, these types of systems can be easily gamed and still disconnected. Consequently, they usually cannot efficiently prevent overproduction or offer real-time production tracking from, e.g., the web or the Internet. Furthermore, these types of systems do not allow true digital twins to be created, which could be used along the supply chain to record data about and allow interactions with products.

The disclosed activation techniques address these issues at their source by allowing a so-called “digital twin” for every physical product to be associated and activated during manufacturing. Activation may involve a context of the physical product, including, e.g., a Factory that produces the product, a zone within the Factory that produces the product, and a purchase order specifying the product. Based at least in part on unique digital identities, this digital-twin system (which is also referred to herein as an “activation system”) may prevent the production of backdoor or grey market goods, may allow monitoring of parallel imports through consumer interactions with the product, and may help prevent the production of counterfeits. So, a digital identity associated with a physical product preferably includes, at a minimum, a unique identifier. And an Active Digital Identity (“ADI”) preferably includes, at a minimum, a digital identity+information regarding an associated product in a cloud repository, including an indication as to whether the digital twin has been activated. An example of such information includes context information (e.g., manufacturing information such as Factory identifier, Factory zone or assembly line information, location information, associated purchase order, etc.), product lifecycle, activation location and dates, material source, shipping information, factory identifiers. Additional examples are provided below. We use the terms “digital twin” and “ADI” interchangeably.

In the present disclosure, the terms “activation” and “commission” and their derivatives are used interchangeably. They should be understood to be equivalent. Moreover, the terms “deactivation” and “decommission” and their derivatives are used interchangeably. They should also be understood to be equivalent.

When does a product become ‘real’? Is it when a Brand creates a purchase order (PO)? After the product is partially through the manufacturing process? Or maybe when the client purchases the product? In disclosed activation techniques, a product becomes real after it is activated. The activation operation may be both logical and physical. It may be performed by a server or a computer that is universally accessible via a network and may also be reflected in the product tag or the product itself. Thus, for purposes of the following descriptions, a product becomes ‘real’ only after activation.

Moreover, in the disclosed activation techniques, everything from the Brand to the activation server or computer (which is typically referred to as a “Digitization Server” or “digitization computer”) may be part of an activation system that handles the product from creation to retirement, e.g., from a Brand purchase order to retiring the product. One advantage of having the activation techniques is that deactivating a product does not require a physical hold on the product itself. Instead, it may be sufficient to deactivate the product (or related product digital identity) in a cloud-based server or computer.

Note that, in the activation system, “activation” may be a single point in the chain and may also be an accumulation of information throughout the manufacturing process. This can make a code unique to the product/item and may be able to represent the item. Moreover, creating a digital twin (e.g., an ADI) during the activation may be based at least in part on uniqueness derived from the manufacturing process, but also can be created by attaching one or more tags onto the product. Furthermore, it may be possible to include randomness and information regarding the product as part of the identity. It may be a ‘DNA print’ or signature of what we are looking at in the actual code or identifier, such that we can identify, from the code, what the object should be (beyond other metadata already included or associated with the product). Additionally, an activated product may include a prompt on the tag itself to mark it as activated, and a different mark when it is not. This prompt or mark may be one-time set by a scanner or by external automatic feedback from the server or computer. By performing the activation, the use of information may prevent human error and may eliminate duplication risks and misassignment of labels to products. In some embodiments, there may be a unique application programming interface (API) with specific operations that need to be taken or performed in order to activate a product and generate a digital twin.

### BRIEF DESCRIPTION OF THE DRAWINGS

FIG. 1 shows an activation overview.

FIG. 2 depicts an example of the activation solution for item-by-item activation, as opposed to batch item activation.

FIG. 3 depicts an example of the general call flow for batch item activation.

FIG. 4 depicts an assembly/manufacturing activation solution overview call flow.

FIG. 5 is a flow diagram showing a smart tag activation process.

FIG. 6 is a flow diagram illustrating an example of a process for batch activation.

FIG. 7 is a flow diagram illustrating an example process for the activation of non-batch items, e.g., on an item-by-item basis.

FIG. 8 is a flow diagram illustrating an example process for a user gaining application access.

FIG. 9 is a flow diagram illustrating an example of an application startup and sign-in process.

FIG. 10 is a flow diagram illustrating an example of how the barcode scanner is configured with the application in a tablet mode.

FIG. 11 is a flow diagram illustrating pre-activation operations.

FIG. 12 is a flow diagram illustrating an example of an activation process.

FIG. 13 is a flow diagram illustrating an example of a deactivation process.

FIG. 14 is a block diagram illustrating example communication among electronic devices, and an operating environment for an embodiment of the present disclosure.

FIG. 15 is a functional diagram showing calls and services in cloud-based server.

FIG. 16 is a block diagram illustrating an example operating environment for one or more cloud servers.

### DETAILED DESCRIPTION

### Activation Process

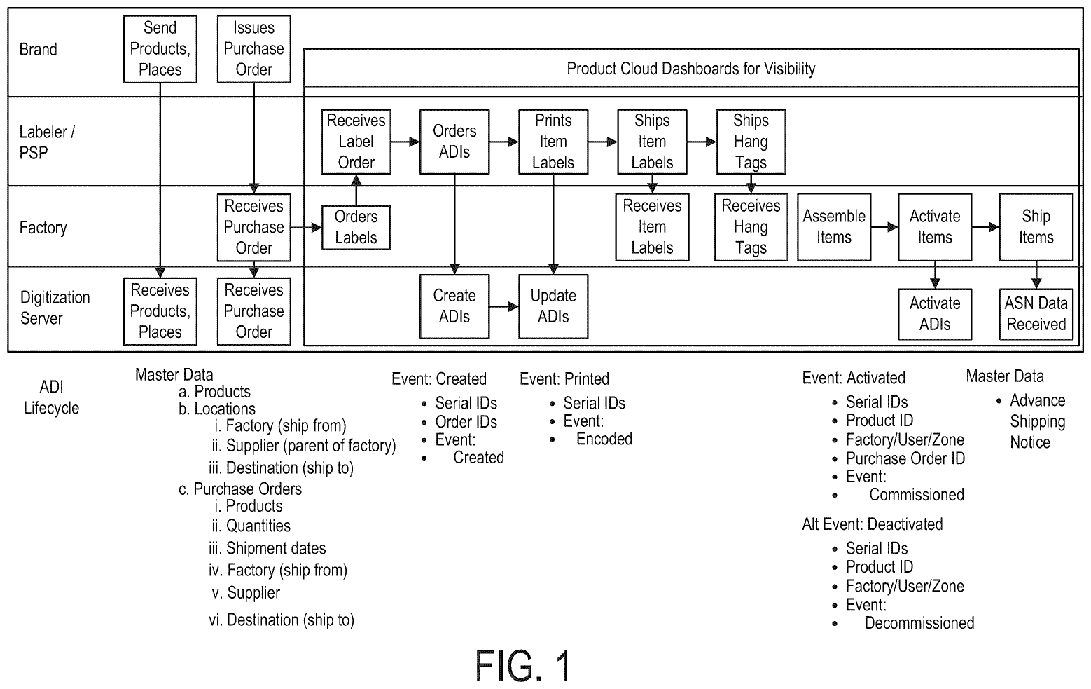

FIG. 1 depicts an example of an overview of an activation solution. There are 4 parties or entities represented in FIG. 1: a Brand, a Labeler/PSP, a Factory and a Digitization Server. We use the term “Brand” in this context to mean a 3rd party (e.g., a retailer) who offers or orders particular product(s) and/or service(s). The term “Factory” refers to a manufacturer and/or location of a place where products are manufactured. For example, if a product is a shirt, the Factory would include machinery and/or tailors to make shirts, and likely packaging and/or shipping services for such shirts. The Digitization Server preferably includes one or more cloud-based server(s) powered by one or more multi-core processors and memory and including graphical interfaces for user interaction. Please see, e.g., FIGS. 15 and 16 for example flow and example operating environment for such cloud-based server(s). Moreover, functionality of the Digitization Server is detailed herein and can be implemented as various cloud-based services. The Labeler/PSP is a print service provider that prints or otherwise generates physical labels (e.g., hang tags or printed labels). The Labeler/PSP is often a 3^{rd} party relative to the Factory, but in some examples may be co-located with the Factory, and in other examples may be a sub-component of the Factory itself. In the FIG. 1 activation system, the Brand (or one or more multi-core computers associated with the Brand) may start an activation process by providing the Digitization Server (e.g., a cloud-based Digitization Server) with Master Data indicating: i) product information; ii) locations (Factory (ship from), supplier, e.g., parent of Factory, and ship to destination); and iii) Purchase Order information (product information, quantities, shipment dates, Factory (ship from), supplier and/or destination (ship to). This Master Data may include product information (such as product identifiers or stock keeping units (“SKUs”)) and Factory information (e.g., Factory floor location, machine identifier, Factory identifier, supplier, destination, etc.). So, the Master Data indicates which products (and an identification of an associated Factory) are intended to be activated. In other words, which physical products should have digital twins activated. (While four parties are represented in FIG. 1, there could be additional parties, e.g., material suppliers, vendors, subcontractors, etc. These parties may also be included in the system and provide inputs considered by the system.)

The Brand preferably issues a purchase order (e.g., product identifier, quantities, shipment dates, Factory (ship from), supplier, and/or shipping to destination), and the Factory and the Digitization Server receive the purchase order, e.g., via computer interface(s) communicating with the Digitization Server. For example, fetching the purchase order via an API of an Enterprise Resource Planner (ERP) (e.g., SAP ERP, Salesforce, Oracle, etc.), receiving it via an API of the Digitization Server, receiving it via by email, retrieving it via a data storage system (e.g., (S)FTP, AWS S3, etc.) or via an API HTTP Callback (e.g., a Webhook). The Factory (or one or more multi-core computers associated with the Factory) may order a set of labels from the Labeler/PSP to fulfill the specific purchase order. After receiving the label order, the Labeler/PSP orders Active digital identities (ADIs) from the Digitization Server. This may be a batch order of Active Digital Identities (e.g., 100× labels ordered may translate to 100× ADIs ordered). As mentioned above, an Active Digital Identity includes: a unique identifier+information associated with a corresponding product available in a cloud memory location, including activation status. The unique identifier may be unique on a per item level (e.g., this first shirt has a unique ID relative to an identical second shirt, which has its own unique ID), per batch level (e.g., each shirt in a batch has the same ID) or per order level (e.g., each shirt in the order including the same ID). In some cases, the ADI includes both a unique identifier and an identifier associated with a purchase order.

As shown in FIG. 1, an event may occur where the ADIs are ordered by a Labeler or Print Service Provider (PSP) and the Digitization Server may respond by creating ADIs for each corresponding ordered label (EVENT: Created). A second event may occur where the labels are printed by the Labeler/PSP (Event: Printed). Once the labels are printed, the Digitization Server may be prompted to update the ADIs that were previously created. Updates may include, e.g., label printer identifier, date printed, employee or location where printed, destination factory identifier. Such information is stored within the ADI and becomes part of lifecycle information associated with the product. The Labeler/PSP may then ship the item labels to the Factory. When these labels are received by the Factory, the labels may or may not be assigned to a specific product at that time. The Labeler/PSP may also send printed hang tags to the Factory. These printed hang tags may be generic tags with no specific SKU or unique identifier. Once the item labels and printed hangtags are at the Factory, the Factory may assemble and activate the items. Activation is when the associated product (e.g., shirt) becomes alive, at least in the digital sense. At this activation process, an event may occur where the Digitization Server activates the ADI. Two events can happen here: Event: Activated, or Alt Event: Deactivated. On an “Event: Activated” occurring, the Digitization Server is prompted by the Factory to update its information within a data structure to reflect activation, e.g., within a document-oriented database program such as provided by MongoDB. MongoDB is classified as a NoSQL database program and uses JSON-like documents with optional schemas. Of course, other data structures can be alternatively used such as tables and arrays, and other database structures, e.g., a SQL database such as PostgreSQL, to reflect a status change to “activation”. Upon activation, the ADI now includes a product identifier associated with the product upon which the label is placed, and preferably updated Factory information (e.g., which machine or Factory zone or tailor made the product), purchase order information, and an indication of activation completed (or “commissioned” status). On an “Alt Event: Deactivated” occurring, the Digitization Server is prompted to update information within the ADI to show that the ADI (and associated product) is decommissioned. For example, if a product is damaged or defective, the ADI (or associated product) may be updated to show a decommissioned status. Next, the Factory may ship the items and Advanced Shipping Notice (ASN) data may be received by the Digitization Server and associated with the ADI. An ASN is typically an Electronic Data Interchange (EDI) message sent from the shipper to the receiver prior to the departure of the shipment from a shipper's facility (e.g., the Factory). The ASN data can be formatted in, e.g., XML format. Such information forms part of the product lifecycle within the ADI of an associated product.

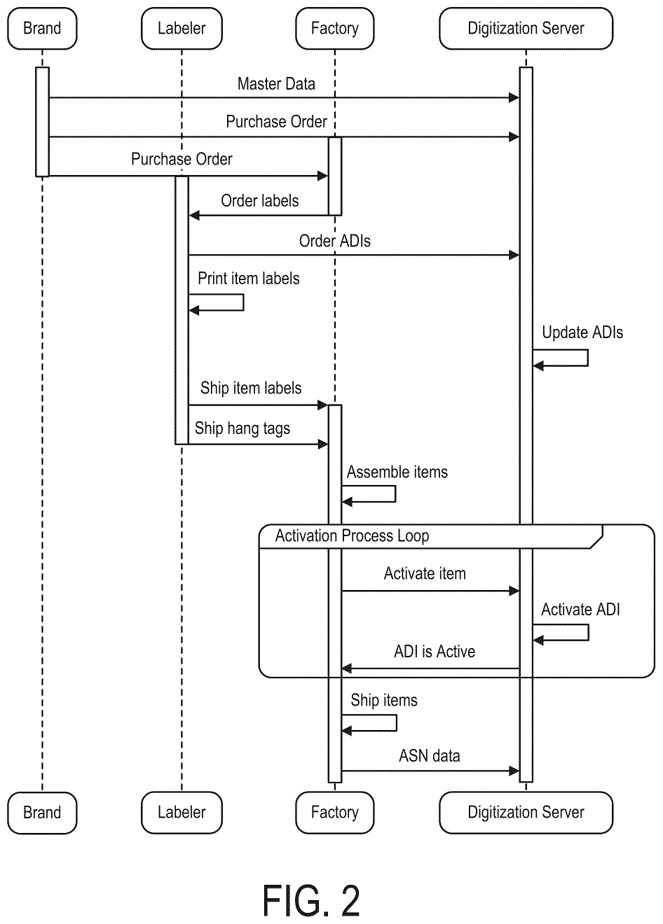

As shown in FIG. 2, the Brand may send master data and the purchase order to the Digitization Server. The purchase order may also be sent to the Factory, and the Factory may order labels based at least in part on this purchase order. The Labeler may order ADIs from the Digitization Server, prints item labels and, after printing, the Digitization Server may update the ADIs based at least in part on information received concerning the printed labels. The Labeler may ship the item labels and any printed hang tags to the Factory. Then, the Factory may assemble the products (e.g., make a shirt) and then attach the printed product labels and/or printed hang tags. The following single-activation operation is one possible embodiment for the activation system. In these embodiments, a single product and its related ADI may be activated. An important part of activation is an activation request communication from the Factory to the Digitization Server to activate the product. The activation request typically includes a unique identifier (e.g., machine readable code from a label) associated with the product and purchase order information. Of course, the activation request may include other product lifecycle information such as manufacturing date, factory identification, assembly line identifier, Brand identifier, material used in product identification, supply chain information, etc. Information can be stored relative to a purchase order, e.g., percentage of order fulfilled, count number activated, etc. This allows for correlation and validation of a product relative to the purchase order. The Digitization Server changes the status of an ADI to indicate that the ADI is active (or “commissioned”); and a return communication is provided from the Digitization Server to the Factory to indicate successful activation of the ADI. This allows the Factory to proceed with distribution of the product. The product is shipped to a distributor (or final retail location) and Advanced Shipment Notice (ASN) data is sent to the Digitization Server. The Digitization Server may update an ADI to include and/or compare the ASN data with the original purchase order information obtained from the Brand and/or Factory. This activation loop process may repeat for each product until all products in the purchase order are completed.

On advantage of activating a product is that a Brand can monitor items as they are produced relative to its purchase order and see how many items are fulfilled in real time. Another advantage of activating a product is that a distributor and retailer and confirm that they are receiving authentic product since they are associated with an active digital twin. Furthermore, a customer can verify that they are purchasing an authentic product by scanning the label and accessing information from the ADI. The ability to access the information itself is a likely indication of authenticity.

In one example, authentication information is sent from the Factory to the Digitization Server. The authentication information may include the printed label (and possibly an image captured of the printed label), purchase order information (or comparison against originally received purchase order information) and even an image of the product (depicting the printed label and/or hang tag). The images can be provided to a trained classifier to classify or characterize the label and product. This can be stored in the ADI for future reference, e.g., at consumer purchase or resale time to determine authenticity. Instead of a trained classifier, a hash or signature can be determined based on the images. In still other examples, image fingerprinting (aka image signature technology) is used, which commonly involves deriving a set of 2D feature points from imagery, and then searching a set of reference image feature points for a closest match, to thereby identify a corresponding reference image. The SIFT, SURF, and ORB algorithms are expected to perform well in this use case.

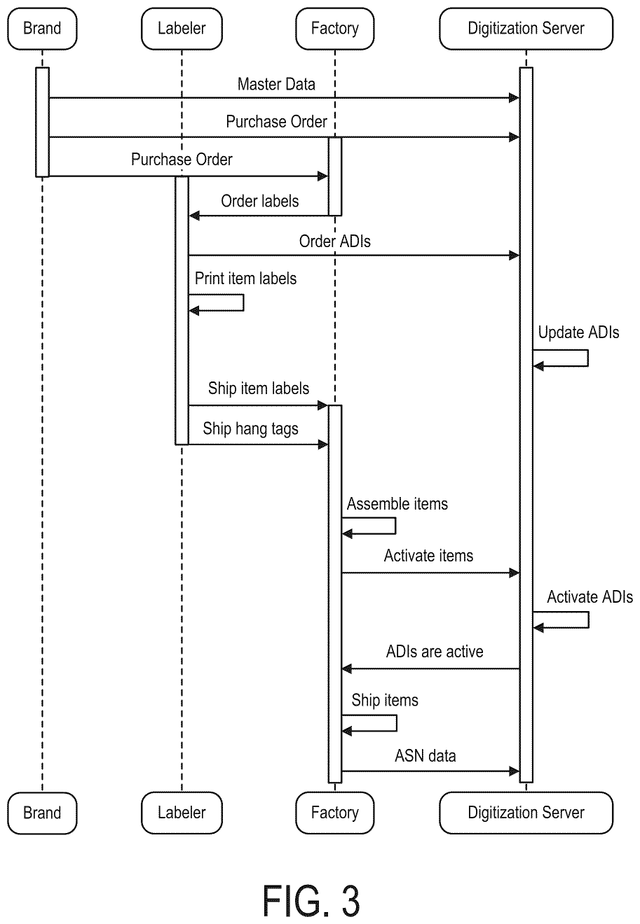

FIG. 3 depicts an example of the general call flow for batch item activation. Note that this is the activation of multiple items in a batch-like fashion. In general, the activation process may be performed in batches. In a batch process, multiple items are manufactured, and corresponding information is provided to the Digitization Server as a group of items, instead of item-by-item. The items in the group may be being activated and the ADIs may be updated.

FIG. 3 represents the same solution overview previously described with reference to FIG. 2 in the form of a call flow. As before, master data may be sent from the Brand to the Digitization Server. The Brand may also issue a purchase order to the Digitization Server and Factory. Then, the Factory may order labels from the Labeler/PSP. The Labeler/PSP may order ADIs and may print item labels. Once these labels are printed, the Digitization Server may update the ADIs that were previously ordered by the Labeler. The update may include, e.g., printer information, destination factory, print employee and/or location information, and other product lifecycle information as may be available. The Labeler may ship the item labels and the hang tags to the Factory. The Factory may assemble products and attach printed labels and/or tags to such products and communicate an activation request to the Digitization Server to activate the items. This may trigger the activation of the ADIs by the Digitization Server (e.g., updating individual ADIs to indicate an activated status). The Digitization Server communicates a successfully activation (or not) notification to the Factory (or to one or more multicore processors associated with the Factory). Only after successful activation may the Factory then ship products; once shipped, associated ASN data may be sent to the Digitization Server. The batch activation may send all products in the batch as part of the ‘Activate Items’ request in FIG. 3. In one example, Factory communicates with Digitization Server via a multi-core processor electronic device (e.g., a Tablet, mobile smartphone or networked computer). One example of such an electronic device is shown in FIG. 14, see item 110. The multi-core processor electronic device includes a buffer, and all products within the batch order are placed in the buffer and communicated one at a time to the Digitization Server for activation. Another example format is a batch file in .csv format; another example is one or more JSON files including product information discussed above per unique identifier. The Digitization Server generates a reply to the multi-core processor computer that indicates activation approval to all items that pass validation and activation. In one example, the validation process includes determining whether the product to be activated includes corresponding information (e.g., matching product identifier, matching SKU, within expected number of allowed products, e.g., this is 82 of 100 products commissioned, etc.) previously received in the purchase order.

Authentication information can be sent from the Factory to the Digitization Server as discussed above.

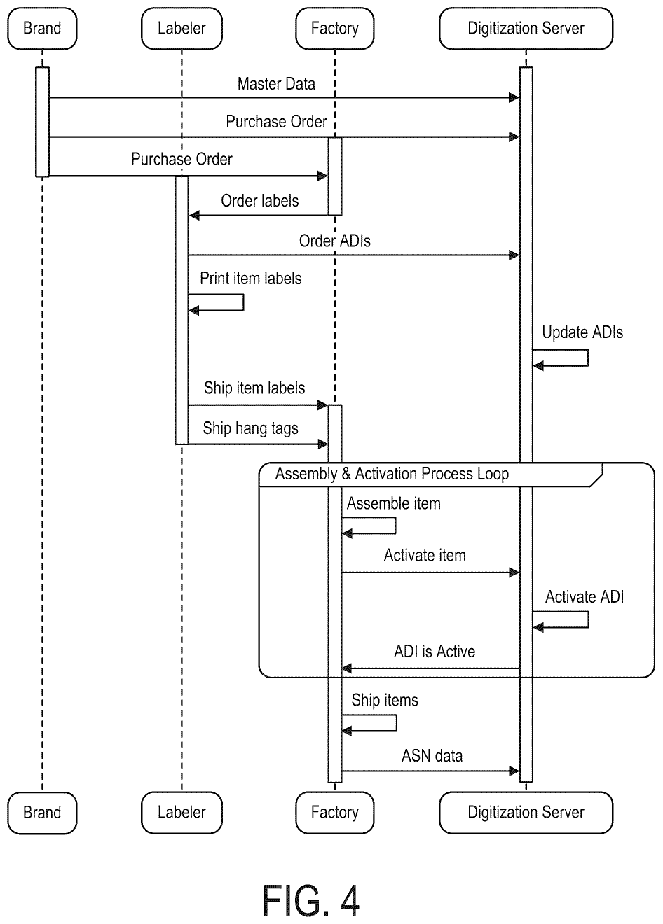

FIG. 4 shows an example of activating a single item while in the assembly/manufacturing process (as opposed to afterwards). FIG. 4 represents the same solution overview previously described with reference to FIGS. 2 and 3 in the form of a call flows. As before, master data may be sent from the Brand to the Digitization Server. The Brand may also issue a purchase order to the Digitization Server and Factory. Then, the Factory may order printed labels (and/or hang tags) from the Labeler/PSP. The Labeler/PSP may order ADIs from the Digitization Server and prints the product labels. Once these labels are printed, the Digitization Server may update the ADIs (as discussed above) that were previously ordered by the Labeler. The Labeler may ship the product labels and/or hang tags to the Factory. The Factory may assemble (e.g., manufacture the product on the assembly line, and attach the printed labels and/or hang tags to the product) the product and activate the products one at a time. An assembled product 132 (FIG. 14) includes a product label 130 and optionally a smart tag 134. After a product is activated, an ADI activation notice may be sent back to the Factory from the Digitization Server. Then, the items may be shipped from the Factory and ASN data communicated to the Digitization Server. The Factory and the Digitization Server may process item-by-item. However, these operations may be performed during the manufacturing process. Here, the activation occurs on the assembly line, as opposed to at a location where the item is packaged and distributed (e.g., sent to a store).

Product activation may also be performed for smart tags as compared to printed labels. A product 132 may include a product tag 130 where the product tag 130 includes an integrated circuit 134 as shown in FIG. 14. The IC may include memory and/or processing circuitry. The memory may include data such as private/public keys and/or unique product identifiers. Such a smart tag may have a shared secret with an ADI housed in a cloud-based computer, such as the Digitization Server. Using this shared secret, the cloud-based computer may provide the smart tag with an activation code once the product becomes alive (or is commissioned). The activation code can be used downstream for product authentication to ensure supply chain integrity and consumer confidence. Smart tags may not be limited to radio-frequency identification (RFID), but also may include inked-circuit based tags or active-ink-based tags that may be augmented using or based at least in part on an environmental change, such as but not limited to a wireless signal. In some embodiments, a scanner device may emit a wireless signal at a specific carrier frequency that the smart tag is designed for. The modulated code conveyed via the carrier frequency may cause the tag to change its appearance and/or display a new code or identifier.

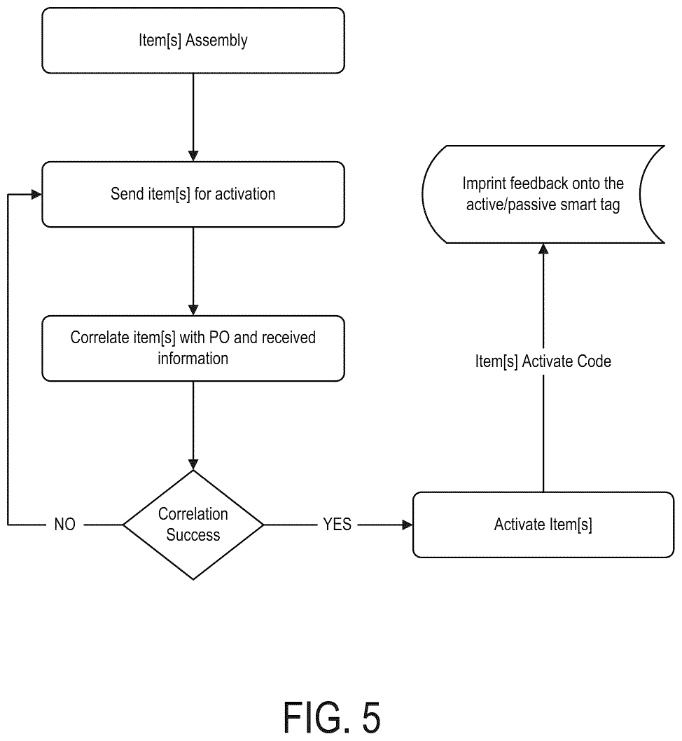

As shown in FIG. 5, an activation procedure may take place for every activation. Notably, an activation request may be associated with a specific physical product, label or tag, broad scanned image (e.g., an image representing the product and its printed label), and/or purchase order (as well as optional additional details as required and described in the disclosed activation techniques) may be sent to the Digitization Server. In some examples, the Digitization Server may use the tag or smart tag information and one or more of the other inputs to create a nonfungible code that is sent back to a one or more multi-core processor computer evaluating the product. If the label is a smart tag, the nonfungible code may be used to access or validate the smart tag. The nonfungible code may include information about the item itself, such that removing the tag from the item may invalidate it. In a particular example, we may use a detailed relationship between the product or tag's unique surface markings (e.g., texture, weave pattern, etc.) and the randomness of the tag placement on a product to generate a unique code, but other techniques can be used. Note that moving or removing the tag and placing it elsewhere may not generate the same tag-to-product relationships, thereby invalidating the tag. In other examples, the tag may reflect the fact that it was activated by changing its color or indicating markings or a sign on to demonstrate the fact that it was activated. In these other examples, the smart part of the tag may include an active ink that allows a one-time change in presence of an RF signal or another environmental influence or trigger.

With reference to FIG. 5, and in one example, during or after product assembly, information is communicated from the Factory to the Digitization Server. The information includes which physical item is being activated. The information may also include Factory location, machine identification, work shift identification, material supplier information, associated Brand, etc. The Digitization Server correlates this item information with the previously received Purchase Order information. In a first example, a correlation may compare a total number of ordered products (e.g., 100 total shirts) from a Purchase Order to a manufactured number associated with the product (e.g., no. 82 or no. 103). If the manufacture number is within the allowed total (e.g., 82/100) then there is a correlation success. In a related example, a non-unique identifier associated with the product (e.g., a SKU) is used to track of items manufactured within a purchase order. For example, each time the SKU is found by the Digitization Server for that Purchase Order, the count is incremented. Thus, the Digitization Server can update a count number associated with items ordered in the purchase order. If not correlated (e.g., 103/100 total), then there is a correlation failure. In a second example, a correlation may compare individual fields within Factory activation information to ADI information (e.g., Purchase Order and/or lifecycle information) for matching data, e.g., item identification number, Factory identifier, label identifier, Brand identifier, etc. Or a hash or other reduced-bit identifier can be generated on all or some of the Purchase Order. A corresponding hash or reduced-bit identifier can be generated on corresponding portions of the item information. If the hashes match or otherwise correspond as expected, then the correlation is successful, and the item is activated. Otherwise, an unsuccessful correlation notification can be communicated from the Digitization Server to the Factory. In some cases, e.g., those involving use of a smart tag on an item, an item success activation code can be communicated back to the Factory and stored in the smart tag.

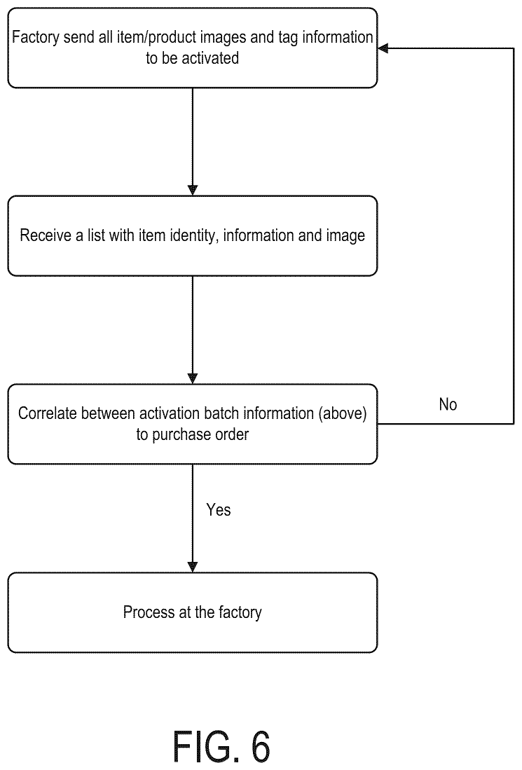

As shown in FIG. 6, the Factory may send multiple item/product images and tag information to be activated. The Digitization Server may receive a list with item identity, information, and, optionally, product image(s). Correlation may occur between the activation batch information and a Purchase Order previously received from the Brand. Correlation can proceed as discussed above on an individual item level or on the batch level. For example, the activation request may specify a particular purchase order. In one example, the purchase order orders 100 blue shirts. The correlation process determines whether the batch request (e.g., number of blue shirts requested to be activated) corresponds with the purchase order (e.g., 100 blue shirts). If the number of products within the batch activation request is less than or equal to the number ordered in the PO, then the correction passes. If not (e.g., the batch activation request is for 107 shirts) then the correlation fails. Correlation may mean that the entire batch activation request fails, or that only the extra 7 shirts activation request fails. It should be noted that a purchase order may include multiple different SKUs with different quantities ordered of each product type (e.g., 100 blue shirts, 57 black shirt and 7000 stylish plaid shirts). The batch activation may include requests for all SKUs, or for just a subset of the SKUs. If there is an issue or correlation that is not successful between an item and purchase order, the process may begin again. If the correlation is successful, the process may continue at the Factory. The batch activation response to the Factory may include a list of activation items that succeeded in order to allow the Factory to correct any mistakes and resend the remaining items.

The use of a product image captured during ADI activation and environmental information may allow for the user to use this information when authenticating an item/product downstream from manufacture. See, e.g., US Patent Publication No. US 2021-0256110 A1, which is hereby incorporated herein by reference in its entirety, for a related discussion.

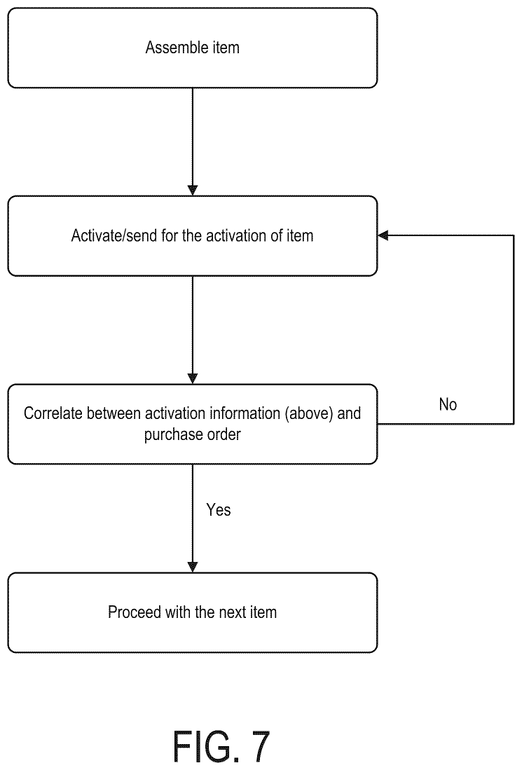

FIG. 7 illustrates an example of a process for the activation of non-batch items, e.g., on an item-by-item basis. This process may be used in the Factory and/or at a distribution location (such as a store). As shown in FIG. 7, the product may be assembled (e.g., manufactured and labeled). Then (or during), the Factory sends an activation request for the assembled product to the Digitization Server. The activation request preferably includes a unique identifier associated with the assembled product and the corresponding purchase order. The activation request may also include an image of the assembled product including the printed label. The correlation between the activation request and Purchase Order may be assessed. If the correlation does not match, the system may repeat the activation/send for activation of an item. If the correlation matches, the system may proceed with the next item. As above, the correlation may look for a comparison of SKU identifiers, Factory identifier, number of units produced, etc.

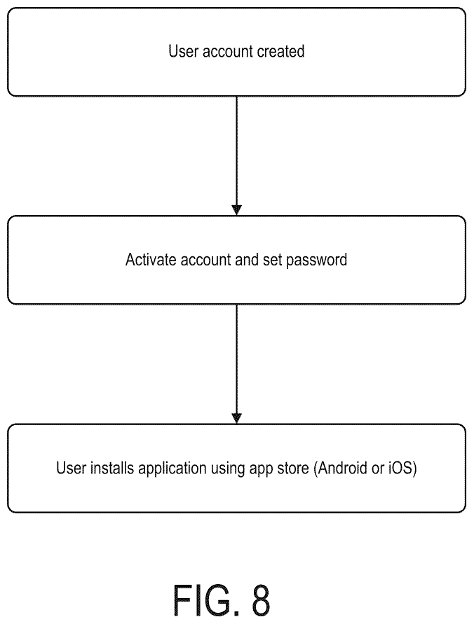

FIG. 8 illustrates an example of a process for a Factory user gaining account access for an ADI activation service. Prior to such, the Factory has established a relationship with the Digitization Server and preferably identifies (e.g., via email addresses or employee badge number) those Factory users designated to set up an activation account. As shown in FIG. 8, the user may set up an account in an account dashboard accessed via web-based interfaces hosted by the Digitization Server. This account may have a ‘Factory user’ or ‘Factory administrator’ role and at least one Factory identifier associated with it. The user may activate their account and set up a password and possibly 2FA authentication. After account creation, the user may go to an application store (e.g., Android or iOS store hosting software or applications for use on portable electronic devices) and install a “product activation application” on a portable electronic device such as a tablet or smartphone. Such a device corresponds to electronic device 110 in FIG. 14. Of course, product activation applications can also be created to run on desktop machines. The product activation application can be a Web application, a native mobile application, or a hybrid application (e.g., using React Native). It can perform activations based on an embedded mobile phone camera, attached camera (e.g., USB Camera or Webcam), embedded or connected mobile phone NFC, RFID, Bluetooth or 5G module, a connected scanning device wired or wirelessly connected to a machine (e.g., laser barcode scanner, image-based scanner, RFID scanner, NFC scanner etc.).

Except where noted, these operations apply to a mobile and tablet mode of operation of the product activation application. Note that there may only be one application for all modes (e.g., mobile and tablet, which are sometimes referred to as a ‘portable electronic device’ or an ‘electronic device’).

Let's again discuss data held within the Digitization Server. In addition to the user data described previously (e.g., username, factory identifier, passwords, etc.), the following data referenced in an activation process may be held or stored in a backend service hosted or controlled by the Digitization Server: master data, purchase orders loaded by the Brand; Factory records (including a Factory identifier); product records (including a product identifier); and/or serialized product identification. Such hosted information may be organized within individual ADIs. And ADIs may include an associated purchase order identifier. That way, ADI associated with a particular purchase order can be identified, and their status checked. Note that unique identifier for a digital identity may include: a primary unique identifier, which may be the backbone for a digital identifier; the identifier of the Factory allocated to an ADI; and/or a lifecycle history of the ADI, which may be represented as supply chain or other events. The primary unique identifier may include a unique identifier that may be compatible with one or more of: a global standards 1 (GS1) digital link, a global trade item number (GTIN), a serial shipping container (SSCC), a serialized global trade item number (SGTIN), an European article number code (EAN), a universal product codes (UPC), an electronic product code (EPC), a global location number (GLN), an international standard book identifier (ISBN), a global returnable assess identifier (GRAI), a global coupon number (GCN), an Amazon standard identification number (ASIN), a global returnable asset identifier (GRAI), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, a pharmaceutical product identifier (PhPID), a serial number, a blockchain address, a blockchain transaction identifier, a hash (e.g., SHA 256), a hash table, a blockchain token, an ERC721 token, an ERC-1155 token, a SBT (soulbound token), a non-fungible token, or a public key from a private/public key pair. In some embodiments, a unique identifier may be generated randomly or pseudo-randomly.

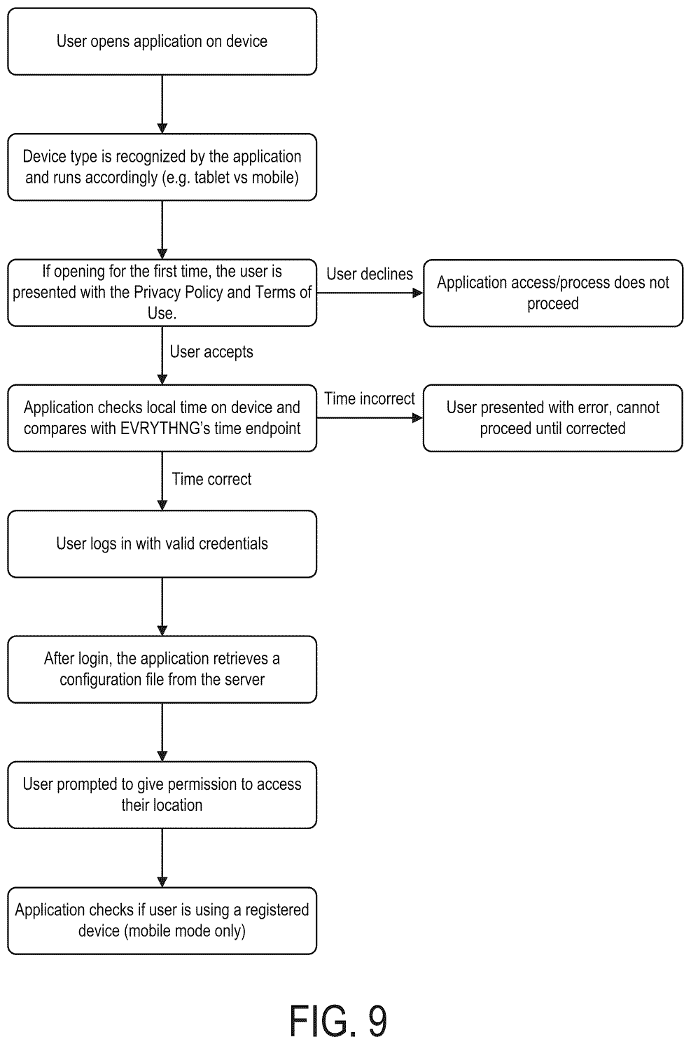

Now further details for product activation application start-up and sign-in. FIG. 9 illustrates an example of a product activation application startup and sign-in process, such as used by a Factory user discussed above. As shown in FIG. 9, a Factory user opens the previously installed product activation application on their electronic device, the type of the electronic device is recognized by the product activation application and runs accordingly (e.g., tablet versus mobile mode). If the product activation application is opening for the first time, the user may be presented with a privacy policy and terms of use. If the user, declines the privacy policy and terms of use the product activation application cannot be accessed. If the user accepts, the product activation application may check the local time on the electronic device and may compare it with the Digitization Server. This allows the product activation application and Digitization Server to match timing, so that events and requests can be correctly recorded. If the time is incorrect, it may be corrected. If the time is correct, the user may be prompted to login with valid credentials.

After login, the product activation application may retrieve a configuration file from the Digitization Server, or a computer associated with or licensed by the Digitization Server, and the user may be asked to give permission to access their environmental information (via device sensors such as GPS, thermometer, barometer, microphone, camera, or sensors connected via Bluetooth, wireless or internet) such as their location, temperature, expected humidity range, expected factory sounds, and/or user biometrics. The configuration file may include: a current version (if the current version of the product activation application differs from the configuration, the product activation application may prompt the user to update their version with a link to their application store), a dual serial mode (if false, only one serialized identity can be associated with the physical item; if true, one or two serialized identities can be associated with the physical item); a fulfillment limit (which may be a threshold beyond which a user will be warned for activating more than the number of ordered items for a given product class in a given purchase order); logging access and secret keys (which may be used to determine the credentials to provide to a third-party logging service; and during operation of the application, all application events and API requests may be logged); a logo (such as a logo of the brand is associated with the items, which may appear in the application menu); offline activation limit (which may be a number of activations that can be cached to the electronic device while it is offline); a primary serial identifier (such as an identifier namespace of the primary serial identifier; e.g., ‘gs1:21’ may represent a serial identifier per the GS1 general specification); secondary serial identifier (which may be an identifier namespace of the secondary serial identifier, e.g., ‘gs1:250’ may represent a secondary serial identifier per the GS1 general specification); a registration change frequency (which may be used in a mobile mode, such as how frequently in months a specific user can change the electronic device identifier that is registered to their account; the user may only operate on one electronic device at a time and, if this is set to ‘0’, the user may switch electronic devices at any time); a scanner configuration disable (which may be used in a tablet mode to override the detection of the scanner configuration; if true, the application may bypass the detection and configuration of a connected barcode scanner); and/or a product identifier pattern (which may be a regular expression defining the format of the product identifier, such as an 8-13 digit numeric only code, e.g., ‘\hat{ }(0-9) [8,13]$’; if the product identifier does not match the configuration pattern, then it may be ignored during activation).

One of the last operations in this process may be the product activation application checking if the Factory user is using a registered electronic device (e.g., in the mobile mode). If the electronic device is not registered and the user does not have a currently registered electronic device or has permission to change their electronic device registration per the change frequency configuration, then the user may be prompted to register their electronic device. If the user already has another registered electronic device and does not have permission to change their registered electronic device per the change frequency configuration, then the user may not be permitted to proceed and may have to exit the application.

There may be several checks and balances that may have to be met by Factory users and their electronic devices. This may allow the Digitization Server to have tight and detailed information about the Factory user and the physical electronic device that provides inputs into the activation process. This security information may prevent ‘gaming’ or misleading the activation system. In some embodiments, a Global Positioning System (GPS) location and/or other environmental information or location coordinates may be used to verify that a user is located within predetermined Factory location so that the Factory is, in fact, activating authorized products.

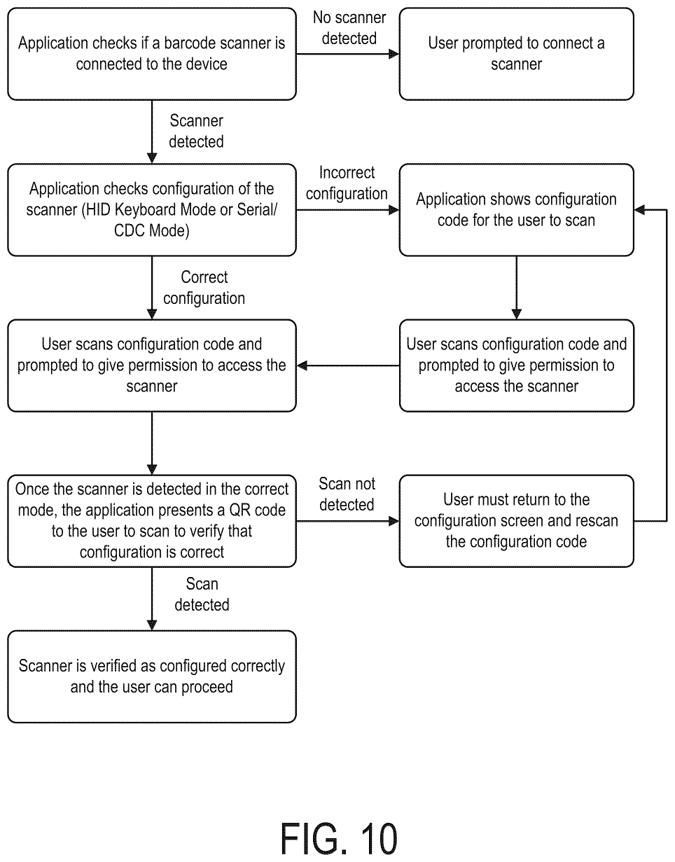

FIG. 10 illustrates an example of how a 2D scanner (e.g., scanning device 136, FIG. 14) is configured with the product activation application in a mobile or tablet mode. A smartphone or tablet (e.g., electronic device 110 in FIG. 14) may be running the product activation application. As shown in FIG. 10, the application may check if a 2D scanner is connected to the electronic device. For example, electronic device 110 (FIG. 14) may be connected physically (via wires or cabling) or wirelessly (via Radios 126-1, 126-4, e.g., Bluetooth) to scanning device 136. If there is no scanner detected, the user may be prompted to connect a scanner. Alternatively, the user may be prompted to activate a camera co-located with the electronic device (e.g., a smartphone or tablet camera). If the scanner is detected, the application may check the configuration of the scanner to determine if the scanner is in a human interface device (HID) keyboard mode or a serial/communication device class (CDC) mode. If the configuration is not correct, the product activation application may display (or cause to be displayed on a device display screen) a configuration code that the user must scan with the 2D camera. This configuration code may vary based at least in part on the specific model of the 2D scanner and/or a dual serial mode (if true, the configuration code may restrict the scanner to quick response (QR) codes; if false, the configuration code may allow scanning of linear codes, such as UPC, EAN, code 128 and code 39, as well as two-dimensional codes, e.g., a QR code). Once the user has scanned the configuration code, they may be prompted to give permission to access the scanner. Once the scanner is detected in the correct mode, the product activation application may cause to be displayed a QR code that must be scanned in order to verify that configuration is correct. If the QR code scan is detected by the product activation application, the 2D scanner may be verified as configured correctly and the user can proceed. If the scan is not detected, the user may have to return to the configuration screen and re-scan the configuration code.

In some embodiments, a menu provided by the product activation application may include one or more of the following: ‘activation’ (which is selectable to open an activation graphical user interface); ‘deactivation’ (which is selectable to open a deactivation graphical user interface); ‘change zone’ (which is selectable to open to an account, Factory, and zone selection interface); ‘change purchase order’ (which is selectable to open to a purchase-order selection graphical user interface); ‘check QR code’ (which is selectable to open a check QR code graphical user interface); ‘logs’ (which is selectable to open a logs graphical user interface); ‘offline activity’ (which is selectable to open an offline activity graphical user interface); ‘help and support’ (which is selectable to open a help and support graphical user interface); and/or log out’ (which is selectable to log out and returns to a sign-in interface). Note that, at any time following the start-up, sign in, and 2D scanner configuration process, the user preferably can switch between graphical user interfaces from the menu using one or more of these options.

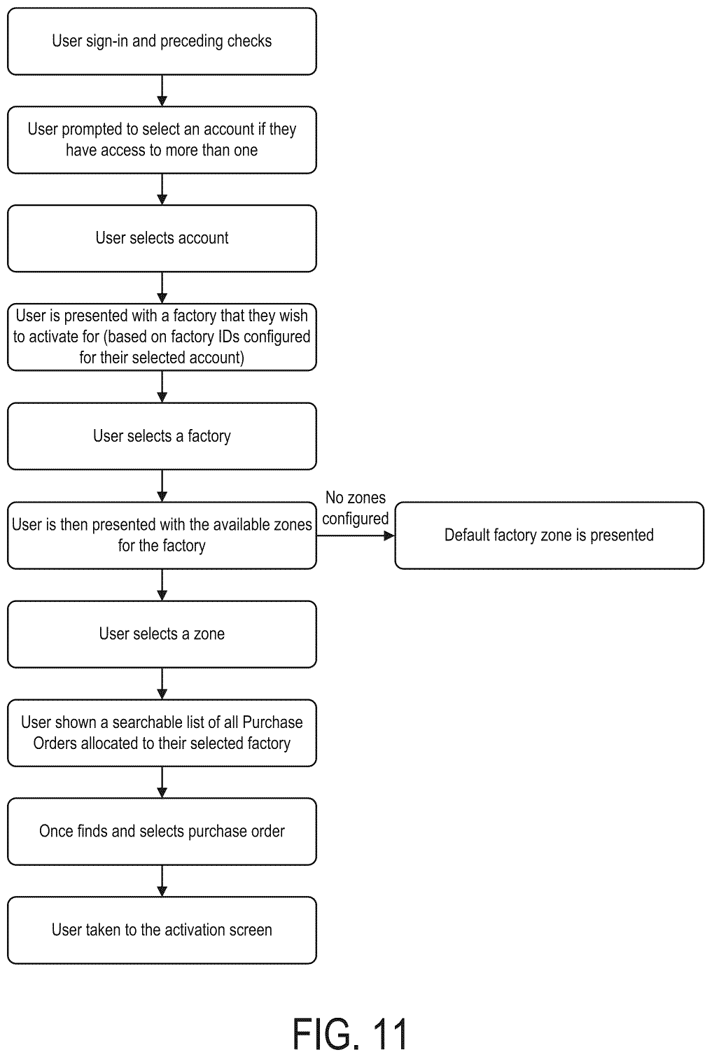

The operations shown in FIG. 11 may be needed for product activation and may occur as a pre-activation stage. Note that in some embodiments these operations may be used to establish the validity of the activation process. If they are not performed, the user may be prompted to return to the appropriate selection graphical user interface. After sign-in and the preceding checks, the user may be prompted to select an account if they have access to more than one. The account may be the specific Brand the user is attempting to access. Then, the user may select an account and may be presented with a Factory that they wish to activate for. The user may select the Factory and may be presented with available zones within the Factory, such as a numbered production line, machinery number, packing station, read point, etc. If no zones are configured, the default ‘Factory’ zone may be presented. Otherwise, the user may select a zone. After selecting account, Factory, and zone, the user may be shown a searchable list of purchase orders allocated to their selected Factory (and/or zone). The user may filter the list by typing in a purchase order identifier, or by other search criteria. Once the user has found their purchase order in the list, they may select it. This may take them automatically to the product activation graphical user interface.

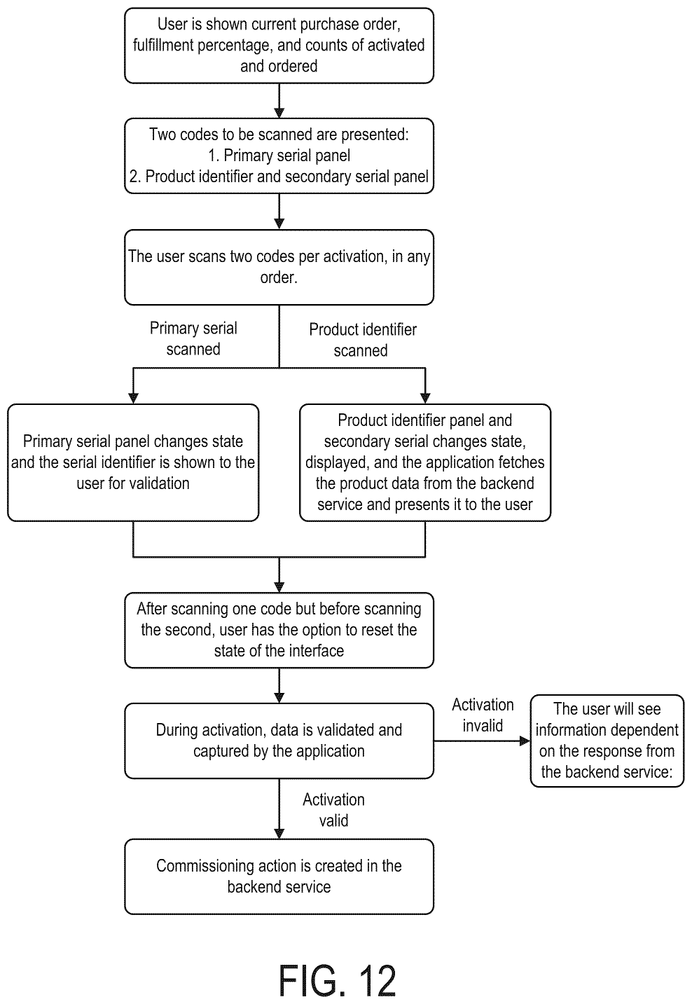

FIG. 12 illustrates an example of a product activation process. A Factory user may be shown (e.g., via a graphical user interface provided by the product activation application running on an electronic device) a selected purchase order at the top of a display graphical interface, e.g., with the percentage of product activations as a proportion of the order quantity (a fulfilment percentage), as well as counts of activated and ordered items. This data may be refreshed by calling the backend service of the Digitization Server periodically, e.g., every few seconds, so that the user has a real-time view of the fulfillment data. In another configuration, the Digitization Server pushes updates to active product activation applications as they become available. In one mode of operation, the user may be able to tap an expand icon to view products or items associated with the purchase order, along with their size and color information, fulfillment percentage, and/or activated/ordered counts. When we use the terms “backend service” we mean a backend service hosted or provided by the Digitization Server.

In the following operation, two display panels (or two areas within a display zone) on an electronic device display screen are provided via a graphical user interface provided by the product activation application running on an electronic device. The display panels can be displayed side by side on one display page, or as sequential pages. The two display panels show at least two codes to be scanned, one on each display panel. The two codes to be scanned are located on or carried by the physical product, e.g., i) a first code on a printed label sewn or affixed to the product, and ii) a second code on a hang tag or other code area. The two codes include: a primary serial code (we also refer to this code as a “unique identifier” above when discussing a “digital identity”), and a product class identifier. The product activation application can be configured to operate such that the Factory user scans at least these two codes per activation, in any order. That is, the Factory user points the 2D scanner, imager, or other scanner (e.g., a mobile/tablet camera) at a first code carried by a sewn-on label or tag. Once the first code is decoded, the product activation application prompts (via display interface panel showing a successful scan) the Factory user to capture the second code carried by the label or hangtag. Once the second code is decoded, the product activation application generates a successful scan indicator (e.g., via a display panel state change). Note that the unique identity may be associated with the physical item (the ‘primary serial code’). This may represent or be the unique identifier of the ADI or “digital twin” of the item. Moreover, the primary serial code may be embedded in any type of printed code that supports encoding of a serial number, but it may typically be embedded in a two-dimensional code, such as a QR code, data matrix or digital watermark. In some embodiments, the primary serial code may be embedded in any type of electronic tag that supports the encoding of a serial number, such as a near-field communication (NFC) tag or an RFID tag. The product class identifier may be associated with the physical item. This may be embedded in any type of printed code or electronic tag that supports the encoding of a product class identifier. Typically, the product class identifier in a non-unique identifier, meaning that it is not unique per that specific item. Examples of a product class identifier may be a trade item identifier, such as a GTIN or an SKU code. In a dual serial mode, the code containing the product class identifier may also contain a serialized identity associated with a component of the item, such as a price ticket, packaging, hidden watermark, etc. (the ‘secondary serial’). Some examples of the secondary serial may include: an SGTIN encoded in a GS1 digital link QR code, an EPC encoded in an RFID tag, and/or digital watermarking containing a plural-bit payload, e.g., a serialized GTIN+. Examples of digital watermarking technology can be found, e.g., in U.S. Pat, Nos. 5,862,260, 6,345,104, 6,614,914, 6,993,152, 7,340,076, 7,352,878, 9,182,778, 9,380,186, 9,401,001, 9,449,357, 9,747,656, 10,453,163, and 10,652,422, and in PCT Published Application No. WO2016153911 and WO2019165364, which are each hereby incorporated herein by reference in its entirety.

When the primary serial code is scanned, the primary serial panel may change state and the primary serial code (or “unique identifier”) may be shown to the user for validation. For example, the panel may include a graphical icon that appears orange until a corresponding code is scanned, and then it turns green. Once scanned, information can be retrieved to be displayed including product size, color and tag serial (if available). When the product class identifier is scanned, the product identifier panel and product class identifier panel may change state (e.g., a graphical icon may turn from orange to green), the product identifier and product class identifier may be displayed, and the application may fetch associated product data from the backend service of the Digitization Server and may present it to the Factory user, via the product activation application, which may include information such as the product identifier, the size of the item, the color of the item, etc.

After scanning one code, but before scanning the second code, the user may have the option to reset the state of the user interface. During activation, the following data may be validated by the application: the product class identifier of the product class that is associated with the purchase order (if not, an error may be shown to the user); and/or whether the fulfilment limit has been exceeded. Notably, if the fulfillment limit is 1.03 and the number of ordered items for a given product class in a given purchase order is 100, when the user tries to activate an item above the order quantity, but up to the quantity multiplied by the fulfilment limit (in this example, 1.03×100=103), they may see a warning displayed in the user interface). Alternatively, when the user tries to activate an item that exceeds the quantity multiplied by the fulfilment limit (in this example, 104 or greater), a warning display box may appear in the user interface for each product activation, and they may have to dismiss it to continue.

During activation, the following data may be captured and sent to the Digitization Server backend service: a primary serial code; a secondary serial code (in the dual serial mode); a product class identifier associated with the physical item; an activating Factory; a zone within the Factory (such as a production line number, packing station, or read-point); a purchase order selected by the user via PO search bar; a location (if user has given permission, this may be derived from electronic-device location services, such as GPS; otherwise, this may be derived from IP address of the API request to the backend service); electronic device metadata (such as a unique electronic device identifier; an electronic device model and Brand; a connection type, e.g. Wi-Fi or cellular; a scanner model; an electronic device operating system; and/or an application version); the date and timestamp of the activation (for example, if in offline mode, the actual date and time of the activation may be captured and sent when online); and/or a time difference between a scan of the first code and a scan of the second code (which may be used for analytics to track efficiency of Factory processes).

During product activation, the Digitization Server may validate: whether an item is encoded, e.g., printed if it is a printed tag, or written to the data element if it is an electronic tag (if not, the request may be rejected and an error may be shown to the user in a user interface); whether the serialized identity associated with the physical item has been allocated to the activating Factory (if not, the request may be rejected and an error may be shown to the user in a user interface); whether the purchase order has been allocated to the activating Factory (if not, the request may be rejected and an error may be shown to the user in a user interface); and/or whether an identifier of the product class is associated with the purchase order (if not, the request may be rejected and an error may be shown to the user in a user interface).

If the activation is valid, a commissioning action (activation notification) may be created in the Digitization Server. This commissioning action may capture: some or all of the preceding data sent to the Digitization Server; and/or a unique event identifier to trace an event if shared with third parties. Note that the commissioning action may also change the state of the ADI, including: a product record specified in the request may be associated with the ADI; the purchase order specified in the request may be associated with the ADI; for the dual serial mode; the secondary serial specified in the request may be associated with the ADI; and/or the commission state of the ADI may be set to activated.

If the activation is not valid, the Factory user may see through displayed information in the production activation application information dependent on the response from the Digitization Server. If the item is already activated against a different purchase order identifier and/or a different Factory identifier, the user may be asked if they want to change the purchase order identifier and/or the Factory identifier. If the user confirms that they want to make a change to this information, the item may be deactivated and reactivated using the new purchase order identifier and/or the Factory identifier. If the item is already activated against the same purchase order identifier and Factory identifier, the user may see an ‘item already activated’ message in a user interface. If there is an issue with the data being invalid, the user may be shown an error in the user interface that describes the problem, such as: the primary serial is not recognized; the secondary serial has already been associated with a different item; the Factory allocated to the item is different from the activating Factory; and/or the item is not encoded. If the backend service detects that a product record does not exist for the product identifier sent by the application, a new product record may be created and marked as having been created during activation.

If the connection to the network fails at any point while the product activation application is in operation, it may switch to an ‘offline mode.’ In the offline mode, the following rules may apply: purchase order and product fulfilment data may not be shown on the activation screen; activations may be cached on the electronic device up to the number specified in the offline fulfilment limit configuration; and/or deactivation may be disabled to prevent data corruption and illegitimate activity. During the offline mode, on the activation graphical user interface, an additional banner may appear indicating that the electronic device is offline and showing the number of offline activations cached. When the electronic device goes back online, the banner may change to show the progress of uploading of the cached activations. If there are any errors during upload, the banner may change state to indicate that there were errors. At any time, the user can click on the more information panel to go to the offline activation screen. The offline activation cache may persist between application sessions, e.g., if the user exits the application and there are cached activations, then those activations may be processed the next time the user signs into the application. On the offline activation screen, a summary of offline activity may be presented to the user, including the number of offline activations uploaded and any upload errors. For each error, specific information on the response from the backend service may be included or listed.

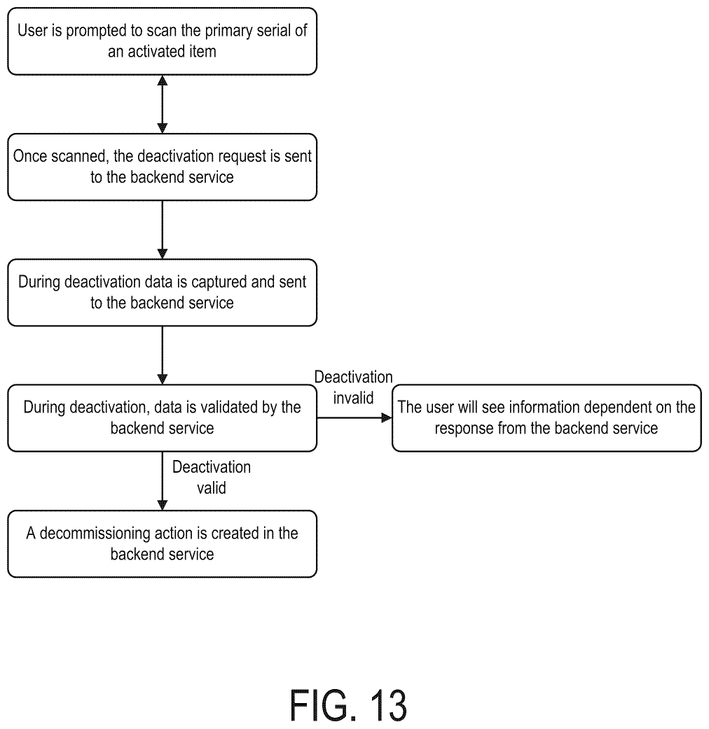

As shown in FIG. 13, in the deactivation graphical user interface, the user may be prompted to scan the primary serial code of an activated item. Only a primary serial code may be deactivated, secondary serial codes may not be deactivated. This may avoid a situation where a secondary serial code becomes detached from the physical item and the physical item is then deactivated but cannot be located. Once a primary serial code is scanned, the deactivation request may be sent to the Digitization Service.

During deactivation, the following data may be captured and sent to the backend service: the primary serial; the deactivating Factory; the zone within the Factory (such as a production line number, packing station, or readpoint); the purchase order selected by the user; the location (if the user has given permission, the location may be derived from electronic-device location services, such as GPS; otherwise, the location may be derived from IP address of API request to the backend service); and/or electronic-device metadata (such as a unique electronic device identifier; an electronic device model and Brand; a connection type, e.g., Wi-Fi or cellular; a scanner model; an electronic device operating system; and/or an application version).

During deactivation, the following data may be validated by the Digitization Service: the item is activated (if the item is not activated, the request may be rejected, and an error may be returned to the user); the serial is recognized; and/or the deactivating Factory is associated with the item.

If the deactivation is valid, a decommissioning action may be created in the backend service that captures: the preceding data sent to the backend service, a unique event identifier to trace the event if shared with third parties, and decommissioning actions. This decommissioning action may also change the state of the ADI, which may include: the product record may be disassociated with the ADI; in dual serial mode, the secondary serial may be disassociated with the ADI; and/or the commission state of the ADI may be set to deactivated.

If the deactivation is not valid, the user may see information dependent on the response from the backend service. If there is an issue with the data being invalid, the user may be shown an error that describes the problem, such as: the primary serial is not recognized, the secondary serial cannot be used to deactivate, and/or the item is not activated.

On the Check QR Code graphical user interface, the user may scan a primary serial identifier to retrieve the following information, which may be displayed in a user interface: the activation status (such as activated, deactivated, or not found); the scanned identifier (the primary serial); other identifiers (e.g., the secondary serial); the purchase order associated with the item; the Factory identifier associated with the item; the ship-to destination of the item if it is associated with a purchase order; the product identifier if it is associated with a product; and/or a full history of all events relating to this item (such as commissions, decommissions, and/or errors).

Other product activation application functionality is now discussed. From a log graphical user interface, the most recent log events captured during operation of the application are displayed. From a help and support graphical user interface, access the application user guide and the Factory activation support portal for raising issues related to the activation process are provided. If the account owner chooses to, they can have some (e.g., a subset) or all of the events sent to a third party in real time via a transport protocol, such as hypertext transport protocol (HTTP), WebSockets, or MQTT. The subset may be restricted based at least in part on any metadata associated with the event, including: an event type (commission, decommission or error); activating Factory; activating user; purchase order identifier; and/or product identifier. This data feed may be used for a variety of purposes, e.g., sending electronic product code information system (EPCIS) events to a scan-pack system to prevent the packing of unactivated items by the Factory. In another example, sending EPCIS events to a product lifecycle management solution to track the product lifecycle and ensure the complete history of a serialized item is captured.

Vendor performance data captured from the product activation application may be used to provide an evaluation of the absolute and relative performance of each Factory, including: how frequently they attempt to re-activate already activated items; how often they receive process-related errors (such as product not associated with purchase order and/or item not allocated to user's selected Factory), and/or the average interval between scanning the first and second codes per item. Moreover, purchase order fulfillment data captured from the application may be presented to the dashboard user in real time, showing: per purchase order and line item; the current count of activations; and/or alerts for a purchase order that exceeds the fulfillment limit.

### Operating Environment

FIG. 14 shows a block diagram illustrating an example operating environment for Factory users' electronic devices 110 and 112 which may communicate with Digitization Server (e.g., cloud-based computer server(s) 122 and/or 120). This figure shows communication between electronic devices 110 and 112 (such as a cellular telephone, e.g., a smartphone such as an iPhone, Samsung Galaxy, Google Pixel, etc., a tablet such as an iPad or Microsoft tablet, a computer, etc.), access point 114, base station 116 in cellular-telephone network 118, computer 120 and computer 122 in accordance with some embodiments. Access point 114 and base station 116 may communicate with computer 120 and/or computer 122 via network 124 (e.g., such as the Internet) using wireless and/or wired communication (such as by using Ethernet or a communication protocol that is compatible with Ethernet), and may communicate with electronic device 110 using wireless communication (Wi-Fi and a cellular-telephone communication protocol, respectively). Note that computer server(s) 122 and/or 120 may include or form components of a cloud-based computing system, and may host, e.g., Digitization Server. Note that access point 114 may include a physical access point and/or a virtual access point that is implemented in software in an environment of an electronic device or a computer. In addition, access point 114 and/or base station 116 may communicate with electronic devices 110 using wireless communication, while electronic device 112 may communicate with computer server(s) 120 and/or computer server(s) 122 via network 124.

Electronic device 110 includes memory. For example, the memory may include a memory subsystem including dynamic random-access memory (DRAM), static random-access memory (SRAM), and/or other types of memory, including fixed storage devices such as solid-state devices and/or hard drives, etc. The memory may include, e.g., one or more program modules or sets of instructions, which may be executed by one or more multi-core processors. Note that the one or more computer programs may constitute a computer-program application, e.g., including the product activation program. Computer instructions in the memory may be implemented, e.g., in: a high-level procedural language, an object-oriented programming language, and/or in an assembly or machine language. Furthermore, the programming language may be compiled or interpreted, e.g., configurable or configured (which may be used interchangeably in this discussion).

While not shown in FIG. 14, the wired and/or wireless communication with electronic devices 110 and/or 112 may further occur via an intra-net, a mesh network, point-to-point connections, cellular network, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads).

As described further below with reference to FIG. 16, electronic device 110, electronic device 112, access point 114, base station 116, computer server(s) 120 and/or computer server(s) 122 may include subsystems, such as a networking subsystem, a memory subsystem and a processor subsystem. In addition, electronic device 110, scanning device 136, electronic device 112, access point 114 and base station 116 may include one or more transceivers (e.g., “radios”) 126 in the networking subsystems. Such transceivers may allow for, e.g., wireless communication through cellular, Bluetooth, and/or Wi-Fi protocols. More generally, electronic device 110, electronic device 112 and access point 114 can include (or can be included within or can communicate with) any electronic devices with the networking subsystems that enable electronic device 110 and access point 114 to communicate with each other using wireless and/or wired communication. This wireless communication can comprise transmitting advertisements on wireless channels to enable access point 114 and/or electronic device 110 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic device 110 and access point 114, one or more of these instances may be different from the other instances of radios 126.

As can be seen in FIG. 14, wireless signals 128 (represented by a jagged line) are transmitted and received from radio 126-1 in electronic device 110. These wireless signals may be received by radio 126-2 in access point 114 or received by radio 126-4 in the scanning device 136. Notably, electronic device 110 may transmit packets or frames. In turn, these packets or frames may be received by access point 114. Moreover, access point 114 may allow electronic device 110 to communicate with other electronic devices, computers and/or servers via network 124. Or Electronic device 110 may communicate directly with other devices such as scanning device 136.

Note that the communication among components in FIG. 14 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic device 110 and/or access point 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the operating environment shown in FIG. 14 as an example, in alternative environments, different numbers or types of electronic devices may be present. For example, some embodiments comprise more or fewer electronic devices. As another example, in another embodiment, different electronic devices are transmitting and/or receiving packets or frames.

FIG. 15 is a functional diagram showing processing flow and calls between a product activation application (e.g., running on electronic device 110 in a Factory) and Digitization Server (e.g., running on or hosted by computer server 1122). The product action application is alternatively referred to as the “Factory Activation App” in FIG. 15. The various described “services” should be understood to be offered in a cloud-based environment as cloud services and are accessible via the web or internet. The product activation application communicates with the Digitization Server, and in particular, with a Digital Twin service. The Digital Twin service manages ADI's associated with physical products. Recall from above, that an ADI can be created (but not yet activated) by the Digital Twin Service receiving a purchase order or master data from a Brand. The Digital Twin Service may also maintain factory accounts, user information, product information, collection data, etc., to facilitate activation and management of ADIs. The Digital Twin Service may also receive information via a Supply Chain Traceability Service, e.g., ASN information, Factory Events, and Purchase Order information. Information can be obtained via various integrations. E.g., packaging and labelling integrations, ERP integrations, etc. Data re authentication can be provided via Authentication Services and Analytics Engine(s). Of course, we use the term “service” in this context to mean cloud-based services delivered on demand to companies, factories and/or customers over the internet or other network. These services are designed to provide easy access to software applications, databases, and other resources, without the need for internal infrastructure, software and hardware.

We now describe embodiments of a computer server(s) 1122, e.g., which may comprise or host computer servers 122 and/or 120. Computer server(s) 1122 may host or be configured as Digitization Server and related services. Computer server(s) 1122 preferably includes a cloud computing-based infrastructure and may be variously configured to provide different computing service models such as, e.g., Infrastructure-as-a-Service (IaaS), Platform-as-a-Service (PaaS), Software-as-a-Service (SaaS) and/or a hybrid cloud or multi-cloud computing environment. Computer server(s) 1122 may include processing subsystem 1010, memory subsystem 1012, and networking subsystem 1014. Processing subsystem 1010 includes one or more devices configured to perform computational operations. For example, processing subsystem 1010 can include one or more servers, microprocessors, multi-core processors, ASICs, microcontrollers, programmable-logic devices, accelerators, one or more graphics process units (GPUs) and/or one or more digital signal processors (DSPs).

Memory subsystem 1012 includes one or more devices for storing data and/or instructions for processing subsystem 1010 and networking subsystem 1014. For example, memory subsystem 1012 can include dynamic random-access memory (DRAM), static random-access memory (SRAM), and/or other types of memory. In some embodiments, instructions for processing subsystem 1010 in memory subsystem 1012 include: one or more program modules or sets of instructions (such as program instructions 1022 or operating system 1024), which may be executed by processing subsystem 1010. Note that the one or more computer programs may constitute a computer-program mechanism. Moreover, instructions in the various modules in memory subsystem 1012 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1010.

In addition, memory subsystem 1012 can include mechanisms for controlling access to the memory. In some embodiments, memory subsystem 1012 includes a memory hierarchy that comprises one or more caches coupled to a memory in computer server(s) 1122. In some of these embodiments, one or more of the caches can be located in processing subsystem 1010.

In some embodiments, memory subsystem 1012 is coupled to one or more high-capacity mass-storage devices (not shown). For example, memory subsystem 1012 can be coupled to a magnetic or optical drive, a solid-state drive, or another type of mass-storage device. In these embodiments, memory subsystem 1012 can be used by computer server(s) 1122 as fast-access storage for often-used data, while the mass-storage device is used to store less frequently used data.

Networking subsystem 1014 includes one or more devices configured to couple to and communicate on a wired and/or wireless network (i.e., to perform network operations), including: control logic 1016, networking switches (not shown), routers (not shown), an interface circuit 1018 and, optionally, one or more antennas 1020 (or antenna elements) and/or input/output (I/O) port 1030. While FIG. 16 includes one or more antennas 1020, preferred embodiments of computer server(s) computer server(s) 1122 includes one or more nodes, such as nodes 1008, e.g., a network node that can be coupled or connected to a network or link. Thus, computer server(s) 1122 may or may not include the one or more antennas 1020. For example, networking subsystem 1014 may include a networking system based on the standards described in IEEE 802.11 (e.g., a Wi-Fi® networking system), an Ethernet networking system, a cable modem networking system, a fiber optic-based networking system, and/or another networking system.

Networking subsystem 1014 may include or communicate with processors, multi-core processors, controllers, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system.

Within computer server(s) 1122, processing subsystem 1010, memory subsystem 1012, and networking subsystem 1014 are coupled together using one or more bus structures 1028. Bus 1028 may include an electrical, optical, and/or electro-optical connection that the subsystems can use to communicate commands and data among one another. Although only one bus structure 1028 is shown for clarity, different embodiments can include a different number or configuration of electrical, optical, and/or electro-optical connections among the subsystems.

In some embodiments, computer server(s) 1122 includes a display subsystem 1026 for displaying information on a display, which may include a display driver and the display, such as a liquid-crystal display, a multi-touch touchscreen, etc.

Although specific components are used to describe computer server(s) 1122, in alternative embodiments, different components and/or subsystems may be present in computer server(s) 1122. For example, computer server(s) 1122 may include one or more additional processing subsystems, memory subsystems, networking subsystems, and/or display subsystems, and/or one or more firewalls, load balancers, cooling systems, power supplies, etc. Additionally, one or more of the subsystems may not be present in computer server(s) 1122. Moreover, in some embodiments, computer server(s) 1122 may include one or more additional subsystems that are not shown in FIG. 16, such as a user-interface subsystem 1032. Also, although separate subsystems are shown in FIG. 16, in some embodiments some or all of a given subsystem or component can be integrated into one or more of the other subsystems or component(s) in computer server(s) 1122. For example, in some embodiments program instructions 1022 are included in operating system 1024 and/or control logic 1016 is included in interface circuit 1018.

Moreover, the circuits and components in computer server(s) 1122 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1014 (or, more generally, of computer server(s) 1122).

While some portions of the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the factory activation techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both.

### Concluding Remarks

Having described and illustrated the principles of the technology with reference to specific implementations, it will be recognized that the technology can be implemented in many other, different, forms. To provide a comprehensive disclosure without unduly lengthening the specification, applicants incorporate by reference-in their entirety-the patents and patent applications referenced above, including all drawings, including color drawings, and appendices.

The methods, processes, and systems described above may be implemented in hardware, software or a combination of hardware and software. For example, the signal processing operations described above may be implemented as instructions stored in a memory and executed in a programmable computer (including both software and firmware instructions), implemented as digital logic circuitry in a special purpose digital circuit, or combination of instructions executed in one or more processors and digital logic circuit modules. The methods and processes described above may be implemented in programs executed from a system's memory (a computer readable medium, such as an electronic, optical or magnetic storage device). The methods, instructions and circuitry operate on electronic signals, or signals in other electromagnetic forms. These signals further represent physical signals like image signals captured in image sensors, audio captured in audio sensors, as well as other physical signal types captured in sensors for that type. These electromagnetic signal representations are transformed to different states as detailed above to detect signal attributes, perform pattern recognition and matching, encode and decode digital data signals, calculate relative attributes of source signals from different sources, etc.

The particular combinations of elements and features in the above-detailed embodiments are exemplary only; the interchanging and substitution of these teachings with other teachings in this and the incorporated-by-reference patents/applications are also contemplated. Any headings used in this document are for the reader's convenience and are not intended to limit the disclosure. We expressly contemplate combining the subject matter under the various headings.

What is claimed is:

1. A method of activating a digital twin corresponding to a physical product comprising:
receiving from a first party, via a cloud-based service interface, order context information and purchase order information corresponding to the physical product, the order context information including factory information and the purchase order information comprising a purchase order identifier;
receiving from a second party, distinct from the first party, and via a cloud-based service interface, a request to establish an active digital identity (“ADI”) for the physical product, the request comprising a product unique identifier associated with the physical product and a purchase order identifier, and in response to the request, creating the ADI, the ADI comprising the product unique identifier, order context information and the purchase order identifier;
receiving from a factory that is manufacturing the physical product, via a cloud-based service interface, a request to activate the digital twin, the request to activate comprising factory context information, a scanned unique identifier and a non-unique identifier associated with the physical product, and in response to the request to activate, correlating the factory context information and the product unique identifier with the order context information and the scanned unique identifier, and upon a successful correlation, storing the factory context information within the ADI, activating the ADI and communicating a successful activation notification to the factory through a cloud-based service interface, in which the activated ADI is accessible for tracking and authentication of the physical product via a cloud-service interface.

2. The method of claim 1 in which and the purchase order information comprises a count limit number, and the correlating further comprises: i) correlating the count limit number to a number items associated with the non-unique identifier and with the purchase order identifier; and in which the request to activate comprises factory-provided information, and in which the correlation further comprises ii) correlating the factory information with the factory-provided information.

3. An electronic device, comprising:
an interface circuit configured to communicate with a computer;
a processor coupled to the interface circuit;
memory, coupled to the processor, storing program instructions, wherein, when executed by the processor, the program instructions cause the electronic device to perform operations comprising:
activating a product based at least in part on a context of the product, comprising: a Factory that produces the product, a zone in the Factory that produces the product, and a purchase order specifying the product;
pairing at least one unique identifier of the product with a non-unique identifier of the product; and
providing, addressed to the computer, information specifying the context, the at least one unique identifier and the non-unique identifier, wherein the information corresponds to a digital twin of the activated product that is generated and maintained by the computer.

4. The electronic device of claim 3, wherein the purchase order comprises: one or more product types, quantities of the one or more product types, and one or more target destinations of the one or more product types.

5. The electronic device of claim 3, wherein the non-unique identifier comprises or is related to a product type of the product.

6. The electronic device of claim 3, wherein the operations comprise updating a tag associated with the product based at least in part on the activation of the product.

7. The electronic device of claim 6, wherein the tag is associated with the digital twin.

8. The electronic device of claim 6, wherein the updating of the tag comprises multi-factor authentication.

9. The electronic device of claim 6, wherein the tag is associated with a hardware device that performs authentication prior to the updating.

10. The electronic device of claim 3, wherein, prior to the activating, the operations comprise:
automatically detecting whether the electronic device is a cellular telephone, a tablet, or another type of mobile electronic device; and
switching, based at least in part on the detection, between an external scanner mode associated with an external scanner and a native camera mode associated with an image sensor in the electronic device; and
wherein at least some of the information is acquired using the external scanner or an image sensor.

11. The electronic device of claim 3, wherein manufacturing processing operations of the product are associated with the digital twin.

12. The electronic device of claim 3, wherein the operations comprise:
deactivating the product based at least in part on the context; and
providing, addressed to the computer, second information that indicates the product has been deactivated.

13. The electronic device of claim 12, wherein the operations comprise:
providing, addressed to the computer, the unique identifier, a deactivation request for the product, and at least some of the information; and
receiving, associated with the computer, a deactivation response.

14. The electronic device of claim 3, wherein the electronic device comprises a display; and
wherein the operations comprise displaying a user interface with a summary of global production of the product independent of the Factory.

15. The electronic device of claim 3, wherein the operations comprise performing real-time tracking of a lifecycle of a product based at least in part on the digital twin.

16. A computer configured to perform counterpart operations to at least some of the operations performed by the electronic device of claim 3.

17. A non-transitory computer-readable storage medium for use with the electronic device of claim 3, the computer-readable storage medium storing program instructions, wherein, when executed by the electronic device, the program instructions cause the electronic device to perform the operations performed by the electronic device or counterpart operations to at least some of the operations performed by the electronic device.

18. A method for activating a product that is performed by the electronic device of claim 3, wherein the electronic device performs the operations performed by the electronic device.
